(19) United States
(12) Patent Application Publication
(10) Pub. No.: US 2009/0219123 A1
(43) Pub. Date: Sep. 3, 2009

(54) MAGNET UNIT FOR MAGNETRON SPUTTERING SYSTEM

(75) Inventors: Akihiko Fujisaki, Kawasaki (JP); Atsushi Furuya, Kawasaki (JP); Nobuyoshi Yamaoka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/367,222

(22) Filed: Feb. 6, 2009

(30) Foreign Application Priority Data
Feb. 29, 2008 (JP) 2008-050956

(51) Int. Cl. H01F 7/02

(52) U.S. Cl. 335/306

(57) ABSTRACT

According to an aspect of an embodiment, a magnet unit for a magnetron sputtering system includes a base board, an inner magnet fixed to the base board and an outer magnet fixed to the base board. The outer magnet is fixed surround the inner magnet. At least one of a portion of the inner magnet or a portion of the outer magnet is displaceable on the base board.

### CROSS-REFERENCE TO APPLICATION

This application is based upon and claims the benefit of priority to Japanese Patent Application No. 2008-50956, filed on Feb. 29, 2008, the entire contents of which are incorporated herein by reference.

### BACKGROUND OF THE INVENTION

1. Field of the Invention

An aspect of the invention relates to a magnet unit for a magnetron sputtering system.

2. Description of the Related Art

A magnetron sputtering system has generally been used to form various thin films on a substrate, such as a semiconductor substrate. The magnetron sputtering system performs sputtering using plasma while generating a magnetic field in the vicinity of the surface of a target, which is a sputtering material. A rotary magnet cathode is used to effectively utilize a target and form a uniform thin film by sputtering the target. The rotary magnet cathode is a device that rotates a permanent magnet on the rear surface of the target to rotate a magnetic field having a predetermined pattern in the vicinity of the front surface of the target. A magnet unit formed by arranging a plurality of permanent magnets in a predetermined pattern on a base board (which is also referred to as a yoke) made of a soft magnetic material is used to generate the magnetic field having a predetermined pattern.

The plurality of permanent magnets are arranged in a predetermined pattern such that the target is effectively sputtered. In the same arrangement of the magnets, the sputtering speed of the target or the deposition of the target on the substrate depends on the process conditions or the kind of target during sputtering. Therefore, in this case, it is necessary to change the arrangement of the magnets according to the process conditions or the kind of target. In order to change the arrangement of the magnets, magnet units capable of changing the arrangement of some or all of the permanent magnets provided therein have been proposed.

For example, a magnet unit has been proposed in which a ring-shaped magnet is provided on a rotatable base board at a position that is eccentric from the center of rotation of the base board, and another central magnet is provided in the ring-shaped magnet, thereby changing the position of one or both of the ring-shaped magnet and the central magnet (for example, see Patent Document 1).

In addition, a magnet unit has been proposed in which a plurality of strip-shaped magnets are arranged in a predetermined pattern on a base board, and a plurality of magnet segments are provided in a portion of the strip-shaped magnet, thereby changing the position of each of the magnet segments (for example, see Patent Document 2).

Further, a magnet unit of a parallel displacement type, not a rotary type, has been proposed in which a base board is divided into a plurality of plates, and a magnet is provided on each of the divided plates, thereby changing the position of each plate (for example, see Patent Document 3).

### [Patent Document 1]

Japanese Laid-open Patent Publication No. 2004-269952

### [Patent Document 2]

Japanese Laid-open Patent Publication No. 2003-531284

### [Patent Document 3]

Japanese Laid-open Patent Publication No. 2000-212739

Patent Document 1 discloses a technique for changing the position of the entire ring-shaped magnet or the entire central magnet. In order to change the position of the magnet, the magnet is detached from the base plate, and then attached to a different position. Since the magnet used for the magnet unit has a very strong attraction force, it is necessary to detach or attach the magnet using a dedicated jig, and it is difficult for persons other than a magnet unit manufacturer to change the position of the magnet.

As in Patent Document 2, when the position of a portion of the magnet is changed, in a rotary magnet unit, the center of the magnet unit is also changed, and the rotation balance is broken. Therefore, it is necessary to adjust the rotation balance again, and an operation of adjusting the position of the magnet becomes complicated. The magnet unit disclosed in Patent Document 2 arranges a plurality of thin strip-shaped magnets that overlap each other in a predetermined pattern to obtain a magnetic field pattern, but does not form a magnetic field using leakage flux between a pair of magnets.

The magnet unit disclosed in Patent Document 3 is a parallel displacement type, not a rotary type. Therefore, the magnet unit does not consider a rotation balance, and cannot be applied to a rotary magnet unit without any change.

### SUMMARY

According to an aspect of an embodiment, a magnet unit for a magnetron sputtering system includes a base board, an inner magnet fixed to the base board and an outer magnet fixed to the base board. The outer magnet is fixed around the inner magnet, and at least one of a portion of the inner magnet or a portion of the outer magnet is displaceable on the base board.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating the overall structure of a magnetron sputtering system;

FIG. 2 is a plan view illustrating a magnet unit according to a first embodiment;

FIG. 3 is a front view illustrating the magnet unit according to the first embodiment;

FIG. 4 is a plan view illustrating the magnet unit when a sliding portion is displaced;

FIG. 5 is an enlarged view illustrating the leading end of a pressure screw;

FIG. 6 is a cross-sectional view taken along the line V-V of FIG. 5;

FIG. 7 is a plan view illustrating the magnet unit when the sliding portion is displaced;

FIGS. 8A and 8B are diagrams illustrating modifications of a sliding groove;

FIG. 9 is a plan view illustrating a magnet unit including adjustment weights;

FIG. 10 is a front view illustrating the magnet unit shown in FIG. 9;

FIG. 11 is an enlarged cross-sectional view taken along the line XI-XI of FIG. 9;

FIG. 12 is a plan view illustrating a magnet unit including a mechanism that automatically adjusts a central position such that the central position is not changed when the sliding portion is moved;

FIG. 13A is a front view illustrating a pin sliding jig;

FIG. 13B is a side view illustrating the pin sliding jig;

FIG. 14 is a plan view illustrating a magnet unit including two sliding portions fitted into a sliding groove in parallel;

FIG. 15 is a cross-sectional view taken along the line XV-XV of FIG. 14;

FIG. 16 is a diagram illustrating the movement of a sliding portion by a pin sliding jig;

FIG. 17 is a plan view illustrating a magnet unit according to a second embodiment of the invention;

FIG. 18 is a front view illustrating the magnet unit according to the second embodiment;

FIG. 19 is a plan view illustrating the magnet unit when a rotating portion is rotated;

FIG. 20 is an enlarged cross-sectional view taken along the line XX-XX of FIG. 17; and

FIG. 21 is a plan view illustrating the magnet unit having a rotating portion provided in an outer magnet.

### DESCRIPTION OF THE PREFERRED EMBODIMENTS

Hereinafter, exemplary embodiments of the invention will be described with reference to the accompanying drawings.

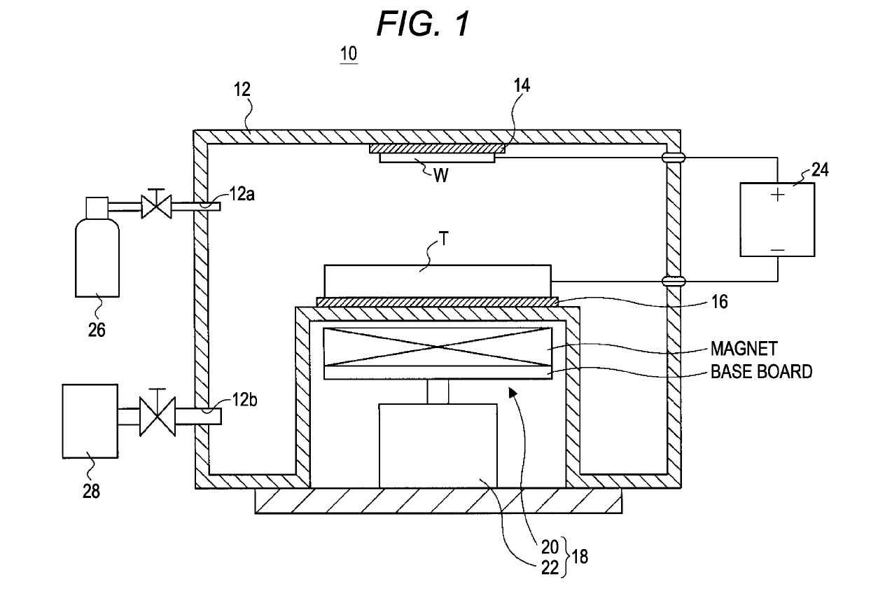

First, the overall structure of a magnetron sputtering system using a magnet unit according to an embodiment of the invention will be described with reference to FIG. 1.

A magnetron sputtering system 10 shown in FIG. 1 sputters a target T, which is a deposition target, in a vacuum chamber 12 to form a film on a substrate W. A substrate holder 14 is provided at an upper part in the vacuum chamber 12, and the substrate W is mounted on the substrate holder 14 made of an insulating material. A target holder 16 is provided below the substrate holder 14, and the target T is mounted on the target holder 16.

A magnetron cathode 18 is provided on the rear side of the target T mounted on the target holder 16. The magnetron cathode 18 includes a magnet unit 20 that generates a magnetic field and a rotating mechanism 22 that rotates the magnet unit 20.

In the above-mentioned structure, the vacuum chamber 12 and the substrate W (substrate holder 14) are connected to the ground. A DC power source 24 applies a negative voltage of several hundred volts to the target T (target holder 16). In general, in a sputtering method, an inert gas, such as argon (Ar), is used to generate plasma. The inert gas is supplied from a gas supply source 26 to the vacuum chamber 12 through a supply port 12a. In addition, the inert gas in the vacuum chamber 12 is discharged by a vacuum pump 28 through an exhaust port 12b.

When a high voltage is applied between the substrate W and the target T, Ar in the vacuum chamber 12 is changed into plasma, and the plasma is confined in the vicinity of the front surface of the target T by the magnetic field generated by the magnet unit 20. Electrons in the plasma collide with Ar atoms by the voltage applied to the target T to generate Ar ions (Ar+). The Ar ions (Ar+) are accelerated by a sheath electric field generated between the plasma and the target T and collide with the target T. In this way, the target T is sputtered, and the sputtered target material is deposited on the substrate W held by the substrate holder 14.

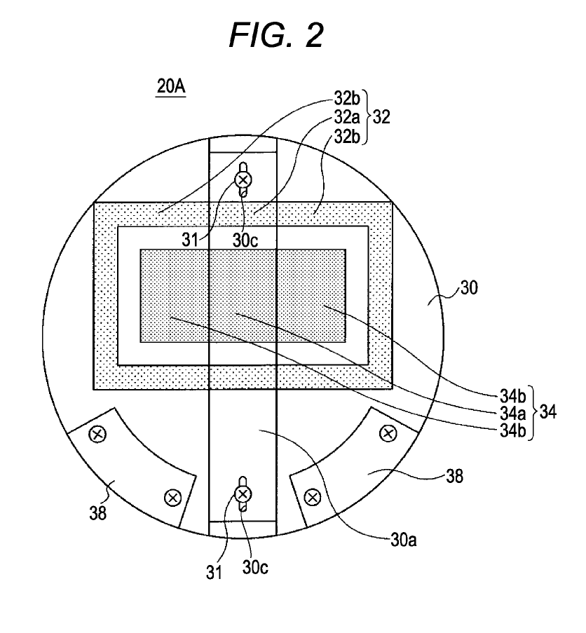

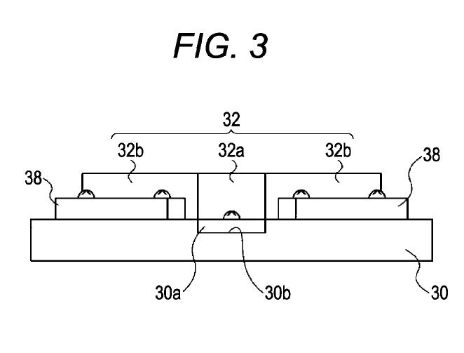

Next, a magnet unit 20A according to the first embodiment will be described. FIG. 2 is a plan view illustrating the magnet unit 20A according to the first embodiment. FIG. 3 is a front view illustrating the magnet unit 20A shown in FIG. 2.

The magnet unit 20A includes a base board 30 formed of a soft magnetic material, and an outer magnet 32 and an inner magnet 34 provided on the base board 30. The outer magnet 32 is a frame-shaped permanent magnet, and the inner magnet 34 is a rectangular permanent magnet. The outer magnet 32 surrounds the inner magnet 34 with a predetermined gap between the outer magnet 32 and the inner magnet 34. The outer magnet 32 is magnetized such that the upper surface thereof serves as the N-pole and the lower surface thereof serves as the S-pole. In this case, the inner magnet 34 is magnetized such that the upper surface thereof serves as the S-pole and the lower surface thereof serves as the N-pole. Therefore, leakage flux is generated from the upper surface (S-pole) of the inner magnet 34 to the upper surface (N-pole) of the outer magnet. The leakage flux is a magnetic field for confining the plasma.

The centers of the outer magnet 32 and the inner magnet 34 are located at a position (eccentric position) that deviates from the center of rotation of the base board 30. In this state, the center of the magnet unit 20A is also located at a position (eccentric position) that deviates from the center of rotation of the base board 30. Therefore, two balance weights 38 are screwed to the base board 30. The balance weights 38 make it possible to align the center of the magnet unit 20A with the center of rotation of the base board 30 and smoothly rotate the magnet unit 20A.

In this embodiment, as shown in FIG. 2, a portion of the outer magnet 32 and a portion of the inner magnet 34 can slide together with a portion of the base board 30. A slidable portion (sliding portion 30a) of the base board 30 has a strip shape, and is slidably fitted into a sliding groove 30b formed in the base board 30. With the sliding portion 30a fitted into the sliding groove 30b of the base board 30, the surface of the sliding portion 30a is flush with the surface of the base board 30.

A portion of the outer magnet 32 and a portion of the inner magnet 34 on the sliding portion 30a are fixed to the sliding portion 30a, and are movable together with the sliding portion 30a. That is, a portion 32a of the outer magnet 32 and the other portion 32b of the outer magnet 32 are formed as individual magnets. The portion 32a of the outer magnet 32 and the other portion 32b of the outer magnet 32 are combined into the frame-shaped outer magnet 32. Similarly, a portion 34a of the inner magnet 34 and the other portion 34b of the inner magnet 34 are formed as individual magnets. The portion 34a of the inner magnet 34 and the other portion 34b of the inner magnet 34 are combined into the inner magnet 34 as a whole. Since the outer magnet 32 and the inner magnet 34 are formed of materials that are difficult to machine, it is preferable that the magnets be fixed to the base board 30 and the sliding portion 30a by an adhesive. In addition, it is preferable that the outer magnet 32 and the inner magnet 34 be symmetric with respect to a line that passes through the center of rotation and is aligned with a direction in which the sliding portion extends. In this way, it is not necessary to balance the rotation of the magnet unit in a direction vertical to the line that passes through the center of rotation and is aligned with the direction in which the sliding portion extends, and it is easy to perform a balance adjusting operation. However, in the structure that balances the rotation of the magnet unit in a direction vertical to the line that passes through the center of rotation and is aligned with the direction in which the sliding portion extends, the arrangement of the outer and inner magnets is not limited to the line symmetry.

In the magnet unit 20A shown in FIG. 2, the sliding portion 30a is fitted into the sliding groove 30b of the base board 30, and the center of the sliding portion 30a in the longitudinal direction is aligned with the center of rotation of the base board 30. In this state, the outer magnet 32 and the inner magnet 34 serve as one magnet, and a desired magnetic field is formed between the outer magnet 32 and the inner magnet 34. In this case, it is possible to change or adjust the magnetic field by slightly displacing the sliding portion 30a in the sliding groove 30b.

Long holes 30c are formed in the vicinities of both ends of the sliding portion 30a so as to be elongated in the direction in which the sliding portion 30a can move. Screws 31 are tightened to the base board 30 through the long holes 30c, thereby fixing the sliding portion 30a to the base board 30.

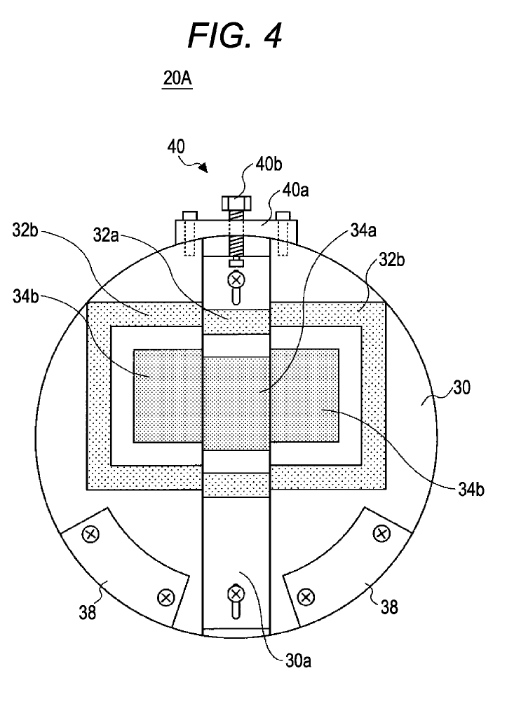

FIG. 4 is a plan view illustrating the magnet unit 20A when the sliding portion 30a is displaced. It is preferable to press the end of the sliding portion 30a to displace the sliding portion 30a. In this embodiment, in order to press the end of the sliding portion 30a to displace the sliding portion 30a, a sliding jig 40 is mounted on the side surface of the base board 30.

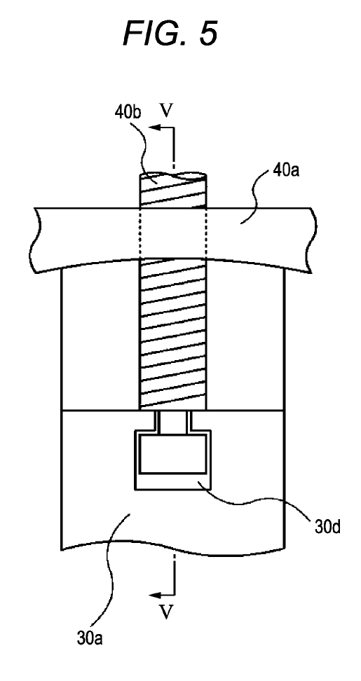

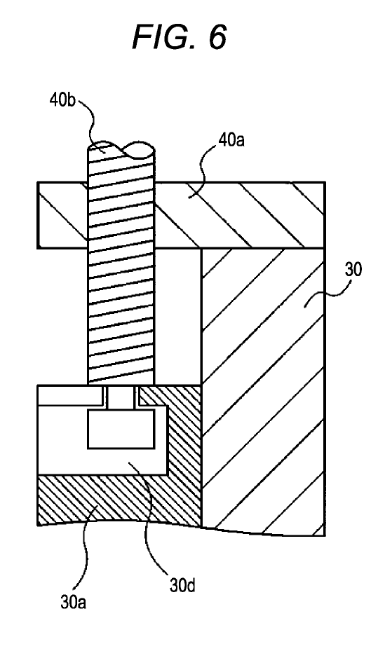

As shown in FIG. 4, the sliding jig 40 includes a supporting portion 40a that is screwed to the side surface of the base board 30 and a pressure screw 40b that is inserted into a screw hole formed at the center of the supporting portion 40a. As shown in FIG. 5, the leading end of the pressure screw 40b is engaged with an engaging concave portion 30d formed at the end of the sliding portion 30a. FIG. 5 is an enlarged view illustrating the leading end of the pressure screw 40b, and FIG. 6 is a cross-sectional view taken along the line V-V of FIG. 5.

It is possible to tighten the pressure screw 40b to press the sliding portion 30a, and it is possible to loose the pressure screw 40b to pull out the sliding portion 30a. In this way, it is possible to displace the sliding portion 30a at a desired position in the sliding groove 30b. As shown in FIG. 4, portions of the outer magnet 32 and the inner magnet 34 can be displaced. When portions of the outer magnet 32 and the inner magnet 34 are displaced, the magnetic field also varies. Therefore, it is possible to adjust the magnetic field by adjusting the displacement of the magnets.

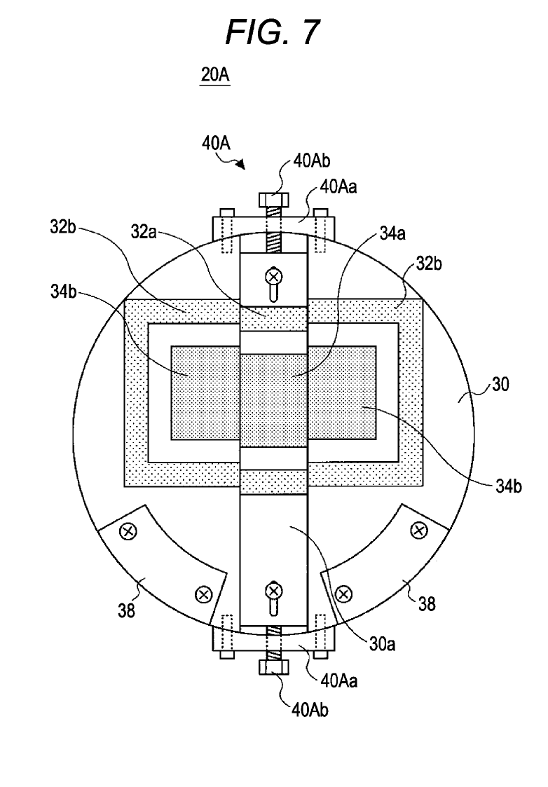

In the example shown in FIG. 4, the pressure screw 40b of the sliding jig 40 is engaged with one end of the sliding portion 30a to apply pressing force and tensile force to the sliding portion 30a. However, as shown FIG. 7, sliding jigs 40A may be provided at both sides of the sliding portion 30a. In this case, the sliding jigs 40A just press the sliding portion 30a, and the leading ends of pressure screws 40Ab of the sliding jigs 40A just come into contact with the ends of the sliding portion 30a. That is, the engaging concave portion 30d is not provided in the sliding portion 30a, and no engaging portion is formed in the leading end of the pressure screw 40Ab.

In addition, the sliding jigs 40 and 40A may be removed after a displacement adjusting operation.

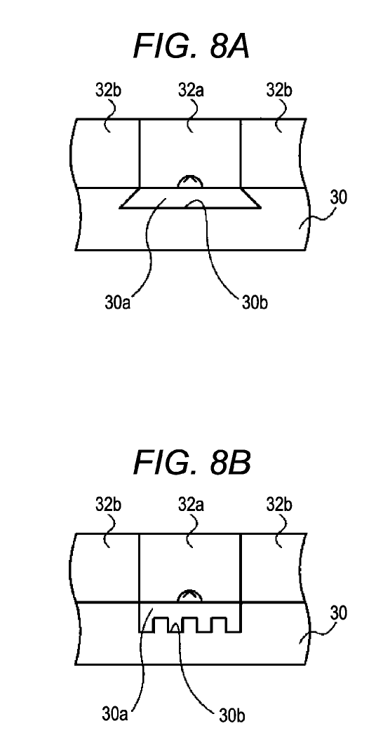

The shape of the sliding groove 30b of the base board 30 into which the sliding portion 30a is slidably fitted is not limited to the rectangular shape shown in FIG. 3, but the sliding groove 30b may have other shapes. For example, as shown in FIG. 8A, the sliding groove 30b may have an inverted trapezoidal shape (so-called dovetail groove) such that the sliding portion 30a does not come off from the base board 30. In this way, it is possible to improve stability during a magnet adjustment operation. Alternatively, as shown in FIG. 8B, comb-shaped uneven portions may be provided in the bottom of the sliding groove 30b, and uneven portions corresponding to the comb-shaped uneven portions may be formed in the bottom of the sliding portion 30a. In this case, magnetic resistance between the sliding portion 30a and the base board 30 is reduced, and it is possible to form a strong magnetic field.

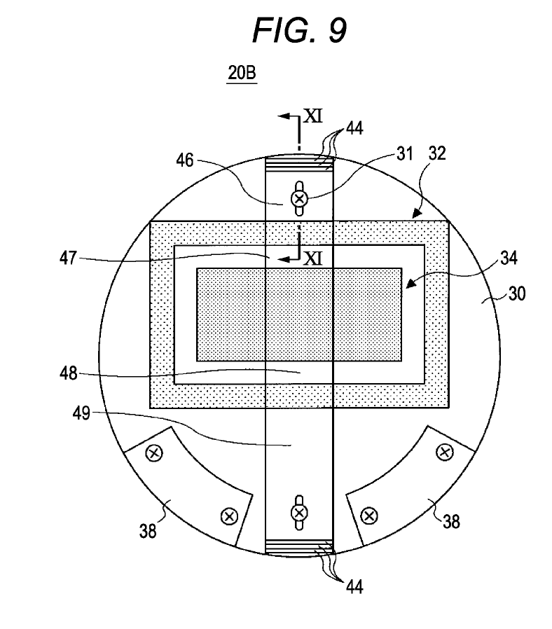

In the above-described embodiment, when the sliding portion 30a is moved, the central position of the magnet unit 20A is changed. When the central position of the magnet unit is changed, the rotation balance is adjusted by changing the positions of the balance weights 38. In addition, it is possible to easily adjust the rotation balance by attaching detachable adjustment weights 44 to both ends of the sliding portion 30a, without changing the positions of the balance weights 38, as shown in FIGS. 9 to 11.

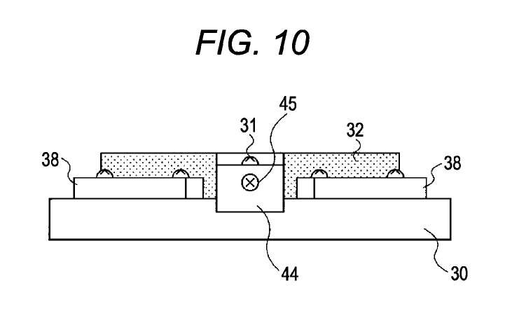

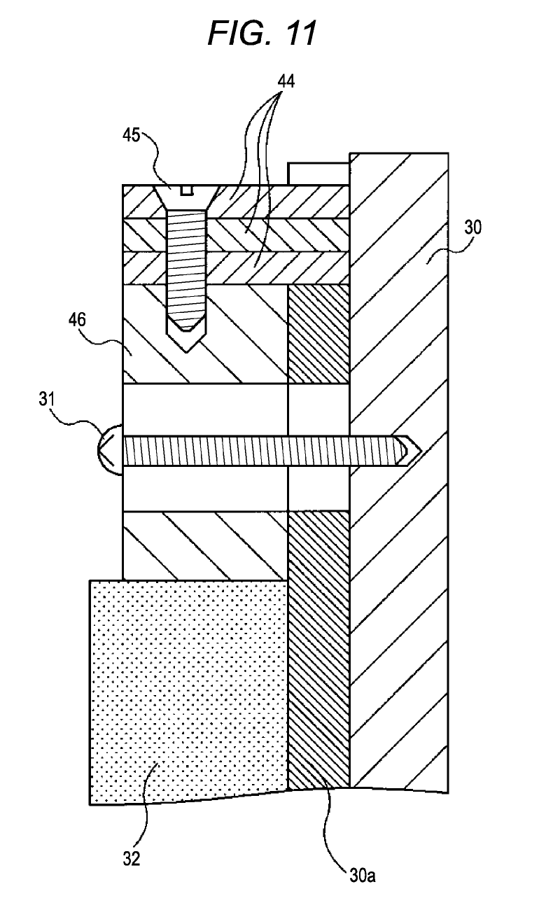

FIG. 9 is a plan view illustrating a magnet unit 20B including the sliding portion 30a having the adjustment weights 44 attached thereto. FIG. 10 is a front view illustrating the magnet unit 20B shown in FIG. 9. FIG. 11 is an enlarged cross-sectional view taken along the line XI-XI of FIG. 9. In FIGS. 9 to 11, the same components as those shown in FIG. 2 are denoted by the same reference numerals, and a description thereof will be omitted.

The magnet unit 20B has the same basic structure as the magnet unit 20A shown in FIG. 2 except that the adjustment weights 44 that are moved together with the sliding portion 30a are provided and non-magnetic members 46, 47, 48, and 49 are provided on the sliding portion 30a. As shown in FIG. 9 and FIG. 10, the non-magnetic members 46, 47, 48, and 49 are slightly lower than the outer magnet 32, and are formed of a non-magnetic material having a specific gravity slightly larger than that forming the outer magnet 32 and the inner magnet 34. In addition, the weight per area of the non-magnetic members is substantially equal to that of the outer magnet 32 and the inner magnet 34. When the non-magnetic members 46, 47, 48, and 49 are attached to the sliding member 30a, the portion 32a of the outer magnet 32, the portion 34a of the inner magnet 34, and the non-magnetic members 46, 47, 48, and 49 mounted on the sliding portion 30a become a strip-shaped member having a substantially uniform weight distribution in the longitudinal direction.

The adjustment weights 44 are screwed to the non-magnetic members 46 and 49 that are provided at both ends of the sliding portion 30a. A plurality of adjustment weights 44 (three adjustment weights in FIG. 9) are provided at one end of the sliding portion 30a, and three adjustment weights 44 are also provided at the other end.

In the state shown in FIG. 9, assume that the sliding portion 30a is moved a distance corresponding to the thickness of one adjustment weight 44 to change the positions of portions of the outer magnet 32 and the inner magnet 34. Then, one end of the sliding portion 30a protrudes a distance corresponding to the thickness of one adjustment weight 44, and the other end of the sliding portion is recessed a distance corresponding to the thickness of one adjustment weight 44. In this case, one adjustment weight 44 is detached from the protruding end, and the detached adjustment weight 44 is attached to the adjustment weights 44 at the recessed end. In the example shown in FIG. 9, when the sliding portion 30a is moved towards the balance weights 38, the sliding portion protrudes a distance corresponding to the thickness of one adjustment weight 44 on the side of the balance weight 38, and the protruding adjustment weight 44 is detached such that two adjustment weights 44 remain on the side of the balance weight 38. Then, the detached adjustment weight 44 is attached to the three adjustment weights 44 on the opposite side. One adjustment weight 44 is added to the three adjustment weights 44 on the opposite side, and four adjustment weights fill up the recessed portion.

As described above, the adjustment weight 44 protruding by the movement of the sliding portion 30a is detached, and the detached adjustment weight is attached to the opposite side. In this way, even when the slider 30a is moved, the central position does not vary, and it is possible to align the central position of the magnet unit 20B with the center of rotation.

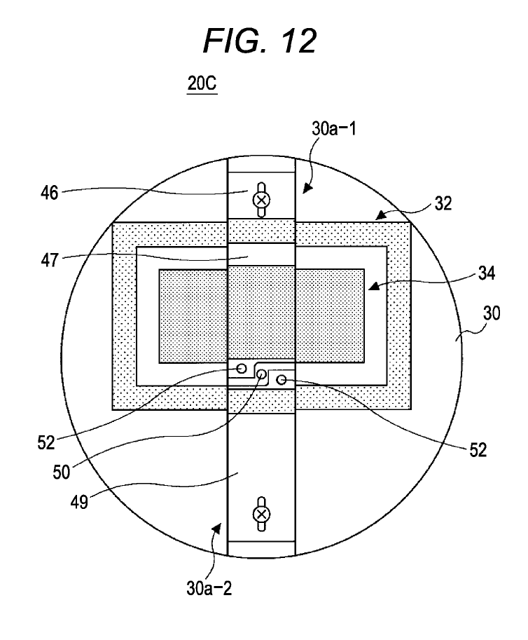

In the example shown in FIG. 9, the adjustment weights 44 are manually detached and attached to adjust a weight balance. However, a mechanism that automatically adjusts the central position when the sliding portion is moved may be provided. FIG. 12 is a plan view illustrating a magnet unit 20C including the mechanism that automatically adjusts the central position such that the central position does not vary when the sliding portion is moved. In FIG. 12, the same components as those shown in FIG. 9 are denoted by the same reference numerals, and a description thereof will be omitted.

In the magnet unit 20C, the sliding portion 30a is divided into two portions by the center of rotation. A fixed pin 50 is provided at the center of rotation of the base board 30. In addition, a movable pin 52 is provided in one of the two divided portions, that is, a sliding portion 30a-1, and another movable pin 52 is provided in the other portion, that is, a sliding portion 30a-2.

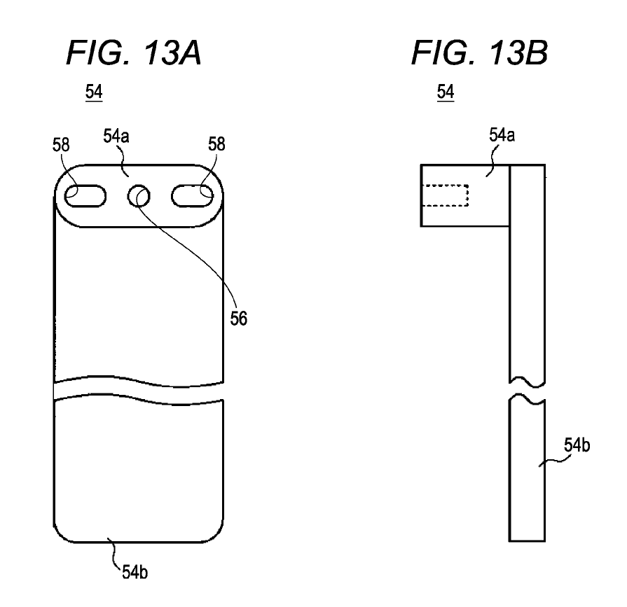

In the above-mentioned structure, it is possible to use a pin sliding jig 54 shown in FIG. 13 to move the movable pins 52 at the same distance from the fixed pin 50 in the opposite directions. FIG. 13A is a front view illustrating the pin sliding jig 54, and FIG. 13B is a side view illustrating the pin sliding jig 54. The pin sliding jig 54 includes a pin engaging portion 54a and a handle portion 54b. The pin engaging portion 54a is provided with a pin hole 56 into which the fixed pin 50 is fitted and pin holes 58 into which the two movable pins 52 are fitted. The pin hole 56 into which the fixed pin 50 is fitted is a circular hole having a sufficient size for the fixed pin 50 to be inserted. The pin holes 58 into which the movable pins 52 are fitted are holes that are elongated in the horizontal direction such that the movable pins 52 can be moved in the holes.

In this way, it is possible to use the pin sliding jig 54 to displace (move) the sliding portion 30a-1 and the sliding portion 30a-2 in the opposite directions. That is, the pin sliding jig 54 is arranged such that the fixed pin 50 and the two movable pins 52 are inserted into the pin holes 56 and 58 of the pin sliding jig 54, respectively, and the pin sliding jig 54 is rotated about the fixed pin 50. Then, the pin holes 58 are rotated on the fixed pin 50. However, the movable pins 52 can be moved only in the direction in which the sliding portion 30a-1 and the sliding portion 30a-2 can move (in the direction in which the sliding groove 30b extends). Therefore, the movable pins are moved in a direction corresponding to the rotation of the pin holes 58, and the sliding portion 30a-1 and the sliding portion 30a-2 are moved along the sliding groove 30b in the direction in which they approach or are separated from each other. FIG. 12 shows the state in which the sliding portion 30a-1 and the sliding portion 30a-2 are slightly displaced to be separated from each other.

As described above, the sliding portion 30a-1 and the sliding portion 30a-2 are moved the same distance in the direction in which they are symmetric with respect to the center of rotation of the magnet unit 20C. Therefore, even when the sliding portion 30a-1 and the sliding portion 30a-2 are moved, the central position of the magnet unit 20C does not vary. As a result, after the sliding portion 30a-1 and the sliding portion 30a-2 are moved to adjust the magnetic field, it is not necessary to perform an operation of adjusting the weights to adjust the central position, and it is possible to simplify an operation of adjusting the magnetic field.

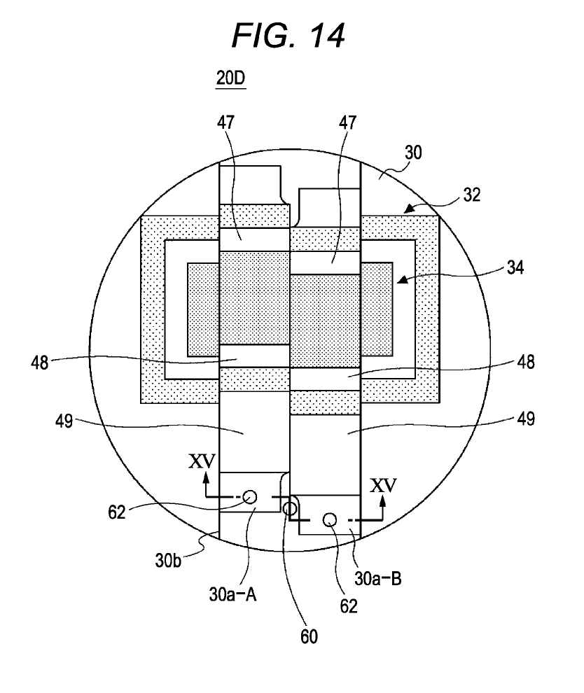

Two sliding portions may be fitted into a sliding groove in parallel so as to move in the opposite directions. FIG. 14 is a plan view illustrating a magnet unit 20D including two sliding portions fitted into a sliding groove in parallel. In FIG. 14, the same components as those shown in FIG. 2 are donated by the same reference numerals, and a description thereof will be omitted.

The magnet unit 20D shown in FIG. 14 includes two sliding portions 30a in a sliding groove 30b. A fixed pin 60 is provided in the vicinities of the sliding portions 30a between the sliding portions 30a on the bottom (that is, the base board 30) of the sliding groove 30b. In addition, movable pins 62 are provided in two sliding portions 30a-A and 30a-B. The two movable pins 62 are provided at both sides of the fixed pin 60 that is erected from the base board 30 so as to be symmetric with respect to the fixed pin.

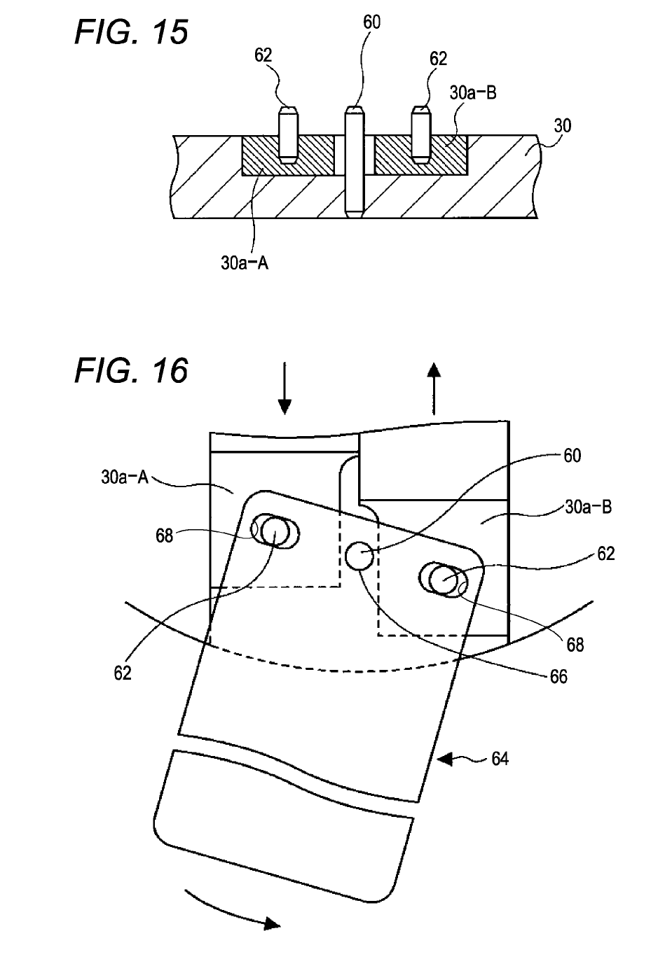

FIG. 15 is an enlarged cross-sectional view taken along the line XV-XV of FIG. 14. The fixed pin 60 is vertically provided in the base board 30. One of the movable pins 62 is vertically provided in the sliding portion 30a-A, and the other movable pin 62 is also vertically provided in the sliding portion 30a-B.

In the magnet unit 20D having the above-mentioned structure, it is possible to use a pin sliding jig 64 shown in FIG. 16 to move the movable pins 62 in the opposite direction. An operation of moving the sliding portions 30a-A and 30a-B using the pin sliding jig 64 is the same as that of moving the sliding portions 30a-1 and 30a-2 in the magnet unit 20C shown in FIG. 12.

That is, the pin sliding jig 64 is arranged such that the fixed pin 60 and the two movable pins 62 are inserted into the pin holes 66 and 68 of the pin sliding jig 64, respectively, and the pin sliding jig 64 is rotated about the fixed pin 60. Then, the pin holes 68 are rotated on the fixed pin 60. However, the movable pins 62 can be moved only in the direction in which the sliding portion 30a-A and the sliding portion 30a-B can move (in the direction in which the sliding groove 30b extends). Therefore, the movable pins are moved in a direction corresponding to the rotation of the pin holes 68, and the sliding portion 30a-A and the sliding portion 30a-B are moved along the sliding groove 30b in the opposite directions. In FIG. 14, the sliding portion 30a-A is slightly moved in the upward direction, and the sliding portion 30a-B is slightly moved in the downward direction.

As described above, the sliding portion 30a-A and the sliding portion 30a-B are moved the same distance in the direction in which they are symmetric with respect to the center of rotation of the magnet unit 20D. Therefore, even when the sliding portion 30a-A and the sliding portion 30a-B are moved, the central position of the magnet unit 20D does not vary. As a result, when the sliding portion 30a-A and the sliding portion 30a-B are moved to adjust the magnetic field, it is not necessary to perform an operation of adjusting the weights to adjust the central position, and it is possible to simplify an operation of adjusting the magnetic field.

Further, in the above-described embodiment, the shapes of the inner magnet and the outer magnet are not limited to those shown in the drawings. However, for example, the inner magnet may have a circular shape, and the outer magnet may have a circular ring shape that surrounds the inner magnet. Alternatively, the inner magnet and the outer magnet may have any shapes as long as portions of the inner and outer magnets can be deformed. The shape of the inner magnet and the shape of the outer magnet may depend on the pattern of a magnetic field to be formed. In addition, the outer magnet 32 does not need to completely surround the inner magnet 34, and the outer magnet 32 may have any shape and arrangement as long as it can form a leakage magnetic field between the outer magnet 32 and the inner magnet 34.

It is preferable that the inner magnet and the outer magnet have shapes and arrangement so as to be symmetric with respect to a line passing through the center of rotation, but the invention is not limited thereto. The inner magnet and the outer magnet may have any shapes and arrangement. In this case, it is preferable to adjust weights to align the central position of the magnet unit with the center of rotation.

In this embodiment, the sliding portion is slidably mounted on the base board such that the center line (a line passing through the center of rotation) of the base board is aligned with the center line of the sliding portion, as shown in the drawings, but the position of the sliding portion is not limited thereto. The sliding portion may be provided such that the center line of the sliding portion deviates from the center line (a line passing through the center of rotation) of the base board.

According to the above-mentioned structure, both the portion 32a of the outer magnet 32 and the portion 34a of the inner magnet 34 are not necessarily fixed to the upper surface of the sliding portion 30a, but any one of them may be fixed to the sliding portion 30a such that it can be displaced.

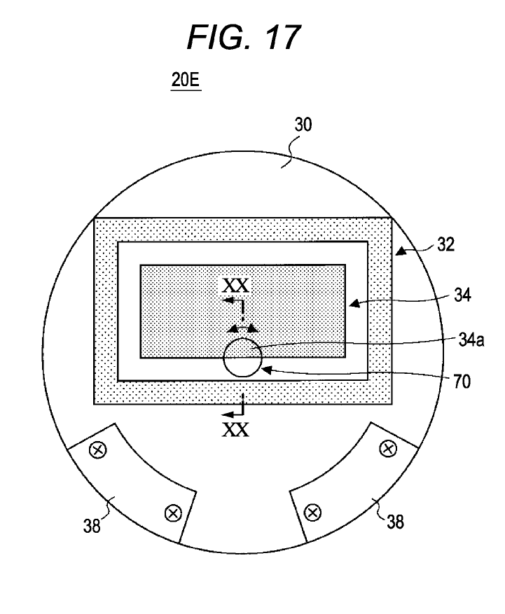

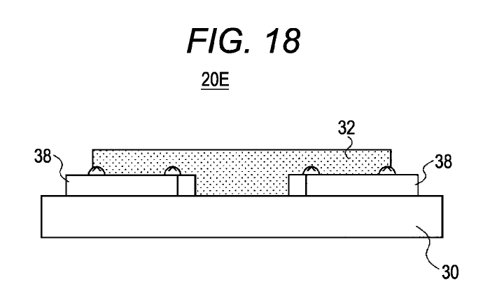

Next, a magnet unit according to a second embodiment will be described with reference to FIGS. 17 to 21. FIG. 17 is a plan view illustrating a magnet unit 20E according to the second embodiment, and FIG. 18 is a front view illustrating the magnet unit 20E. In FIGS. 17 and 18, the same components as those shown in FIG. 2 are denoted by the same reference numerals, and a description thereof will be omitted.

Similar to the magnet unit according to the first embodiment, the magnet unit 20E includes a base board 30, and an outer magnet 32 and an inner magnet 34 fixed to the base board 30. However, no sliding portion is provided in the magnet unit 20E, but the magnet unit 20E includes a rotating portion 70 that can rotate a portion 34a of the inner magnet 34.

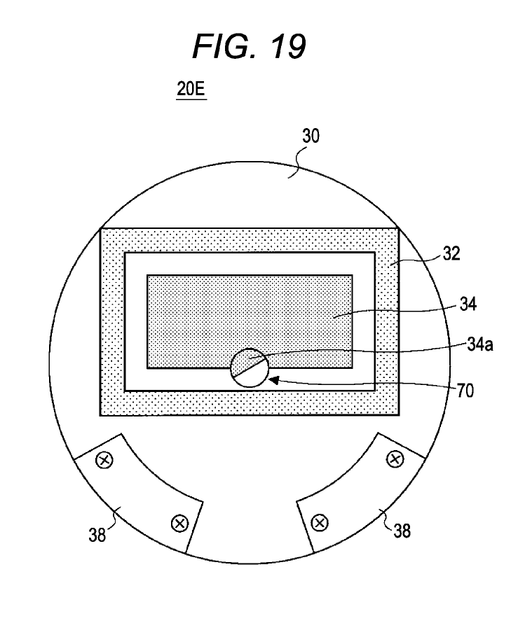

FIG. 19 is a plan view illustrating the magnet unit 20E when the rotating portion 70 is rotated. It is possible to fix the inner magnet 34 with the semicircular portion 34a thereof being rotated by rotating the rotating portion 70. In this way, it is possible to displace a portion of the inner magnet 34 to change or adjust the magnetic field formed by the outer magnet 32 and the inner magnet 34.

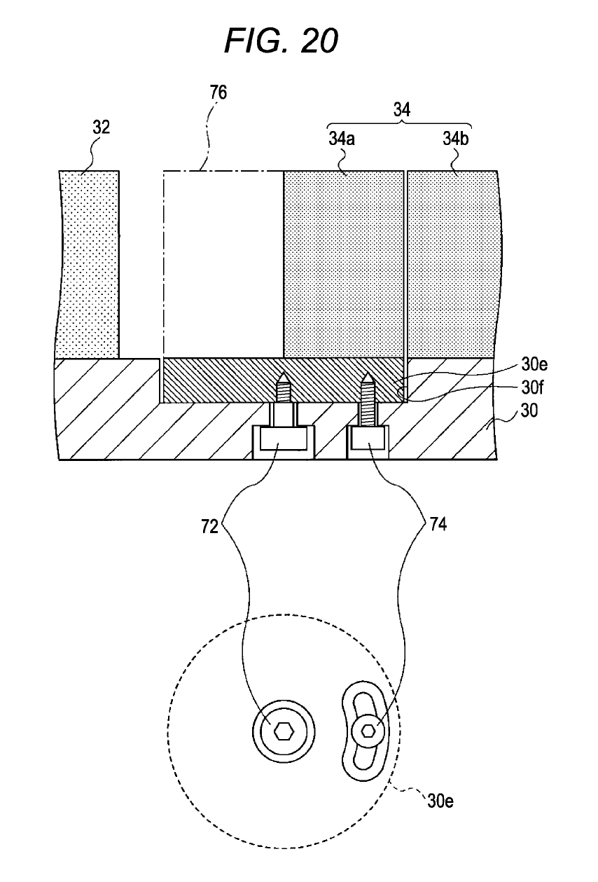

FIG. 20 is an enlarged cross-sectional view taken along the line XX-XX of FIG. 17. FIG. 20 shows the sectional structure of the rotating portion 70. The rotating portion 70 includes a movable base board 30e and the portion 34a of the inner magnet 34. The movable base board 30e is a circular board, and is rotatably accommodated in a circular concave portion 30f formed in the base board 30. The portion 34a of the inner magnet 34 is a cylinder having a semicircular shape in a cross-sectional view, and is fixed to the movable base board 30e by an adhesive.

The movable base board 30e is supported by a detachment preventing member 72 from the rear side of the base board 30 while it is accommodated in the circular concave portion 30f of the base board 30. The detachment preventing member 72 is provided at the center of the movable base board 30e, and the movable base board 30e can be rotated about the center of the detachment preventing member 72 in the circular concave portion 30f.

The movable base board 30e is supported by the detachment preventing member 72, and is fixed by a fixing screw 74. The fixing screw 74 passes through an arc-shaped long hole formed in the rear surface of the base board and is then tightened to the movable base board 30e. When the fixing screw 74 is loosened, the rotating portion 70 including the movable base board 30e can rotate. When the fixing screw 74 is tightened, the rotating portion 70 including the movable base board 30e is fixed. In this way, it is possible to rotate the portion 34a of the inner magnet 34 of the rotating portion 70, and change or adjust the magnetic field formed by the outer magnet 32 and the inner magnet 34.

When the rotating portion 70 is rotated, the portion 34a of the inner magnet 34 is rotated, and the central position of the magnet unit 20E slightly deviates. However, it is possible to adjust the deviation of the central position by changing the positions of the balance weights 38. Alternatively, as represented by a dotted-chain line in FIG. 20, a non-magnetic member 76 having specific gravity and height that are more than or equal to those of the inner magnet 34 and a weight per area that is substantially equal to that of the inner magnet 34 may be provided in the movable base board 30e. In this case, even when the rotating portion 70 is rotated, the central position of the magnet unit does not vary.

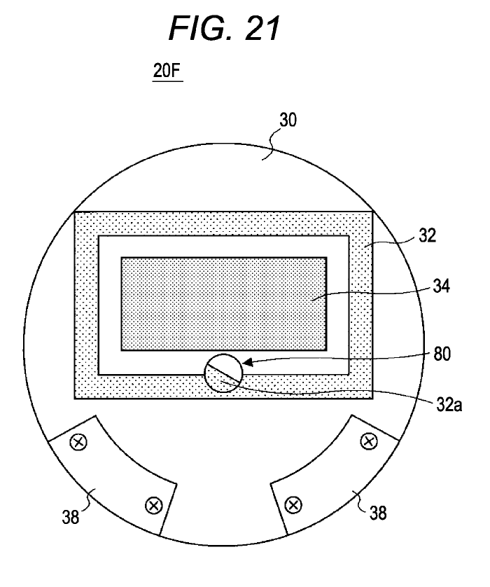

In this embodiment, the rotating portion 70 is provided to rotate the portion 34a of the inner magnet 34. However, as in a magnet unit 20F shown in FIG. 21, a rotating portion 80 that rotates the portion 32a of the outer magnet 32 may be provided. The structure of the rotating portion 80 is the same as that of the rotating portion 70 shown in FIG. 20, and thus a description thereof will be omitted.

In this embodiment, the size of the magnet is half the size of the rotating portion, but the invention is not limited thereto. The magnet may have a circular shape having any size. In addition, the position of the rotating portion is not limited to that shown in the drawings, but the rotating portion may be disposed at any position around the magnet. The rotating portions may be provided in both the outer magnet 32 and the inner magnet 34, and a plurality of rotating portions may be provided in the outer magnet 32 and the inner magnet 34.

As described above, according to the second embodiment, it is possible to change or adjust the magnetic field generated by a magnet unit with a simple operation, without detaching or removing a magnet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnet unit for a magnetron sputtering system, comprising:
a base board;
an inner magnet fixed to the base board; and
an outer magnet fixed to the base board, the outer magnet fixed surround the inner magnet,
wherein at least one of a portion of the inner magnet or a portion of the outer magnet is displaceable in either of two opposite directions on the base board.

2. The magnet unit according to claim 1 further comprising:
a sliding groove formed in the base board; and
a sliding portion having the portion of the inner magnet and the portion of the outer magnet, the sliding portion slidably fitted into a sliding groove.

3. The magnet unit according to claim 2,
wherein the sliding portion is screwed to the base board.

4. The magnet unit according to claim 2,
wherein the sliding groove has a strip shape that is symmetric with respect to the center of the base board, and
the inner magnet and the outer magnet are symmetric with respect to a line that passes through the center of the base board and is aligned with the direction in which the sliding groove extends.

5. The magnet unit according to claim 4,
wherein the inner magnet has a rectangular shape, and the outer magnet has a frame shape having an inner space that is larger than the inner magnet.

6. The magnet unit according to claim 2,
wherein a concave portion into which a jig for moving the sliding portion is fitted is formed at one end of the sliding portion.

7. The magnet unit according to claim 2 further comprising:
a non-magnetic member made of a non-magnetic material, the non-magnetic member being mounted on the sliding portion, the non-magnetic member covering portions other than the portion of the outer magnet and the portion of the inner magnet on the sliding portion, and
a plurality of weights detachably attached to both ends of the sliding portion.

8. The magnet unit according to claim 2,
wherein the sliding portion is divided into two portions that are symmetric with respect to the center of rotation of the base board, and
the two divided portions can be moved the same distance in the opposite directions.

9. The magnet unit according to claim 8,
wherein a first pin is provided at the center of rotation of the base board, and
second pins are provided in the two divided portions of the sliding portion so as to be symmetric with respect to the first pin.

10. The magnet unit according to claim 2,
wherein the sliding portion includes two parallel sliding portions that are symmetric with respect to a line that passes through the center of rotation of the base board, and
the two parallel sliding portions can be moved the same distance in the opposite directions.

11. The magnet unit according to claim 10,
wherein the first pin is provided on the line that passes through the center of rotation of the base board, and
the second pins are provided in the two parallel sliding portions so as to be symmetric with respect to the first pin.

12. The magnet unit according to claim 2,
wherein the sliding groove has a trapezoidal shape in a cross-sectional view, and
the sliding portion has a trapezoidal shape corresponding to the sectional shape of the sliding groove.

13. The magnet unit according to claim 2,
wherein uneven portions are formed in the bottom of the sliding groove, and
uneven portions corresponding to the uneven portions of the sliding groove are formed in the bottom of the sliding portion.

14. The magnet unit according to claim 1 further comprising:
a rotating portion rotated on the base board, and the rotating portion having at least one of the portion of the inner magnet and the portion of the outer magnet.

15. The magnet unit according to claim 14 further comprising:
a circular movable base board having the rotating portion, the circular movable base board rotatably fitted into a circular concave portion formed in the base board.

16. The magnet unit according to claim 15 further comprising:
a non-magnetic member made of a non-magnetic material, the non-magnetic member mounted on the circular movable base board,
wherein the rotating portion has a cylindrical shape.

17. The magnet unit according to claim 15 further comprising: a screw passing through the base board from the rear side, the screw fixing the circular movable board to the base board.
